(19) United States
(12) Patent Application Publication
(10) Pub. No.: US 2023/0356600 A1
(43) Pub. Date: Nov. 9, 2023

(54) DRIVE UNIT

(71) Applicant: EXEDY Corporation, Osaka (JP)

(72) Inventor: Yoshihiro MATSUOKA, Osaka (JP)

(21) Appl. No.: 18/299,936

(22) Filed: Apr. 13, 2023

(30) Foreign Application Priority Data
May 9, 2022 (JP) 2022-076959

(51) Int. Cl. B60L 7/18

(52) U.S. Cl. CPC B60L 7/18; B60L 2220/42; B60L 2260/26; B60L 2240/42; B60L 2240/507

(57) ABSTRACT

A drive unit with enhanced rearward drive force includes a first drive part and a second drive part. The first drive part includes a first electric motor and a first torque converter. The first electric motor is configured to be rotated in a first rotational direction and a second rotational direction. The first torque converter is configured to amplify a torque generated by the first electric motor when the torque generated by the first electric motor is directed in the first rotational direction. The second drive part includes a second electric motor and a second torque converter. The second electric motor is configured to be rotated in the first rotational direction and the second rotational direction. The second torque converter is configured to amplify a torque generated by the second electric motor when the torque generated by the second electric motor is directed in the second rotational direction.

### CROSS-REFERENCE TO RELATED APPLICATIONS

This application claims priority to, and the benefit of, Japan Patent Application No. 2022-076959, filed May 9, 2022, the contents of which are incorporated by reference herein in their entirety.

### TECHNICAL FIELD

The present invention relates to a drive unit.

### BACKGROUND ART

Electric cars travel using an electric motor as a drive source. Japan Laid-open Patent Application Publication No. 2020-172975 describes a drive unit that moves forward by forwardly rotating the electric motor and moves rearward by reversely rotating the electric motor. In addition, the drive unit includes a torque converter to amplify a torque generated by the electric motor.

Such electric cars as described above can sufficiently generate a drive force in forward movement. However, commercial vehicles and so forth are required to sufficiently generate a drive force even in rearward movement.

In view of the above, it is an object of the present invention to enhance a drive force in rearward movement.

### BRIEF SUMMARY

A drive unit according to a first aspect is configured to move a vehicle forward and rearward. The drive unit according to the first aspect includes a first drive part and a second drive part. The first drive part includes a first electric motor and a first torque converter. The first electric motor is configured to be rotated in a first rotational direction and a second rotational direction. It should be noted that the first rotational direction means a rotational direction in which the first electric motor (and a second electric motor to be described as well) is rotated so as to move the vehicle forward, whereas the second rotational direction means a rotational direction in which the first electric motor (and the second electric motor as well) is rotated so as to move the vehicle rearward. The first torque converter is configured to amplify a torque generated by the first electric motor when the torque generated by the first electric motor is directed in the first rotational direction. The second drive part includes a second electric motor and a second torque converter. The second electric motor is configured to be rotated in the first rotational direction and the second rotational direction. The second torque converter is configured to amplify a torque generated by the second electric motor when the torque generated by the second electric motor is directed in the second rotational direction.

According to the configuration described above, the torque generated by the first electric motor is amplified by the first torque converter when the torque generated by the first electric motor is directed in the first rotational direction. Hence, a drive force in forward movement can be enhanced. On the other hand, the torque generated by the second electric motor is amplified by the second torque converter when the torque generated by the second electric motor is directed in the second rotational direction. Hence, a drive force in rearward movement can be enhanced as well.

A drive unit according to a second aspect relates to the drive unit according to the first aspect and is configured such that the first drive part includes a first clutch. The first clutch is configured to allow transmission of the torque generated by the first electric motor when the torque generated by the first electric motor is directed in the second rotational direction and is configured to block transmission of the torque generated by the first electric motor when the torque generated by the first electric motor is directed in the first rotational direction.

A drive unit according to a third aspect relates to the drive unit according to the first or second aspect and is configured such that the second drive part includes a second clutch. The second clutch is configured to allow transmission of the torque generated by the second electric motor when the torque generated by the second electric motor is directed in the first rotational direction and is configured to block transmission of the torque generated by the second electric motor when the torque generated by the second electric motor is directed in the second rotational direction.

A drive unit according to a fourth aspect relates to the drive unit according to any of the first to third aspects and is configured such that the first and second drive parts are different in positional relation between each of the first and second electric motors and each of the first and second torque converters.

A drive unit according to a fifth aspect relates to the drive unit according to any of the first to third aspects and is configured such that the first and second drive parts are identical in positional relation between each of the first and second electric motors and each of the first and second torque converters.

A drive unit according to a sixth aspect relates to the drive unit according to the fifth aspect and further includes a power transmission mechanism. The power transmission mechanism is configured to transmit the torque inputted thereto from each of the first and second drive parts to an output unit. The power transmission mechanism includes a reverse gear. The reverse gear is a component through which rotation of the first or second electric motor is outputted to the output unit after the rotation is reversed in direction.

A drive unit according to a seventh aspect relates to the drive unit according to any of the first to sixth aspects and further includes a controller. The controller is configured to control the first and second electric motors. The controller is configured to execute a first forward movement mode. In the first forward movement mode, the first electric motor is rotated in the first rotational direction, while the second electric motor is rotated in the first rotational direction.

A drive unit according to an eighth aspect relates to the drive unit according to the seventh aspect and is configured such that the controller is configured to execute a second forward movement mode. In the second forward movement mode, the first electric motor is rotated in the first rotational direction, while the second electric motor is stopped.

A drive unit according to a ninth aspect relates to the drive unit according to the seventh or eighth aspect and is configured such that the controller is configured to execute a third forward movement mode. In the third forward movement mode, the first electric motor is idled, while the second electric motor is rotated in the first rotational direction.

A drive unit according to a tenth aspect relates to the drive unit according to any of the seventh to ninth aspects and is configured such that the controller is configured to execute a first braking mode. In the first braking mode, in deceleration during forward movement, the first electric motor is caused to perform a regenerative action, while the second electric motor is stopped.

A drive unit according to an eleventh aspect relates to the drive unit according to any of the seventh to tenth aspects and is configured such that the controller is configured to execute a second braking mode. In the second braking mode, in deceleration during forward movement, the first electric motor is caused to perform a regenerative action, while the second electric motor is rotated in the second rotational direction.

A drive unit according to a twelfth aspect relates to the drive unit according to any of the seventh to eleventh aspects and is configured such that the controller is configured to execute a first rearward movement mode. In the first rearward movement mode, the first electric motor is rotated in the second rotational direction, while the second electric motor is rotated in the second rotational direction.

A drive unit according to a thirteenth aspect relates to the drive unit according to any of the seventh to twelfth aspects and is configured such that the controller is configured to execute a second rearward movement mode. In the second rearward movement mode, the first electric motor is stopped, while the second electric motor is rotated in the second rotational direction.

Overall, according to the present invention, a sufficient drive force can be obtained even in rearward movement.

### BRIEF DESCRIPTION OF THE DRAWINGS

FIG. 1 is a block diagram showing torque transmission paths in a drive unit.

FIG. 2 is a schematic diagram of the drive unit.

FIG. 3 is a schematic diagram of a drive unit according to a modification.

### DETAILED DESCRIPTION

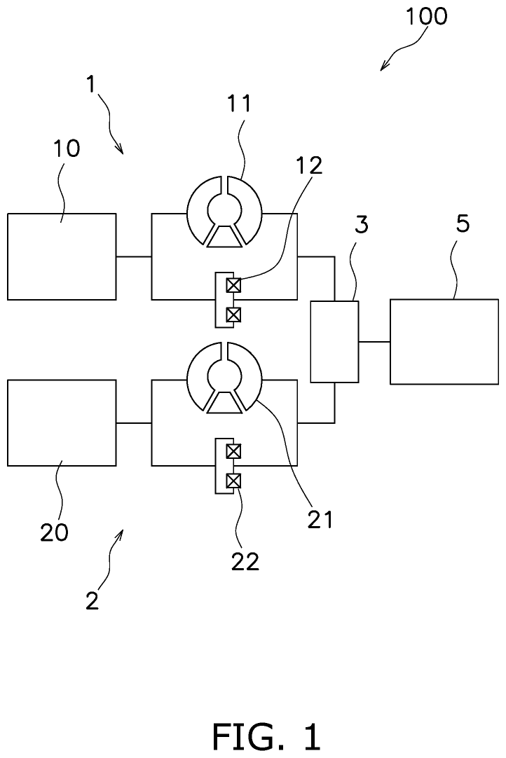

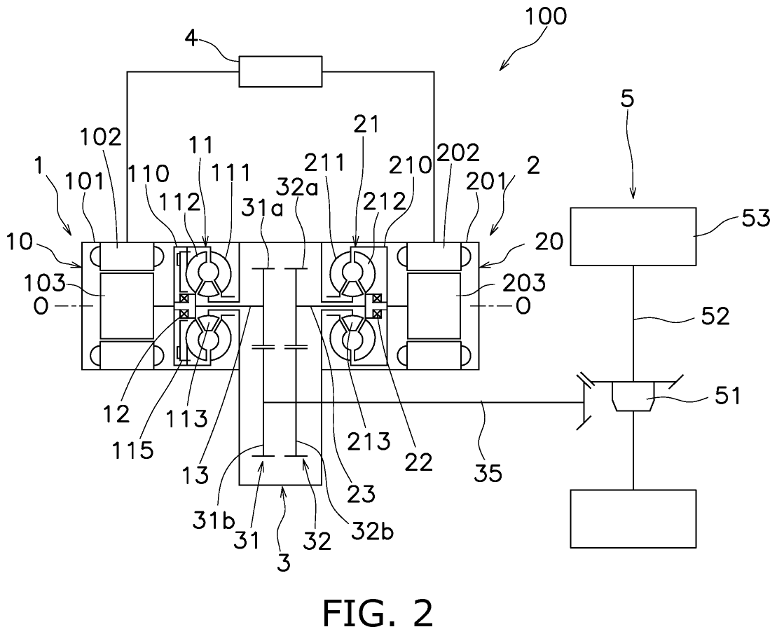

An embodiment of a drive unit will be hereinafter explained with reference to drawings. FIG. 1 is a block diagram showing torque transmission paths in the drive unit, whereas FIG. 2 is a schematic diagram of the drive unit. It should be noted that in the following explanation, the term “first rotational rotation” refers to a direction in which each of constituent members is rotated when a vehicle is moved forward, whereas the term “second rotational direction” refers to a direction in which each of the constituent members is rotated when the vehicle is moved rearward. On the other hand, the term “back-and-forth direction (of the vehicle)” refers to a back-and-forth direction defined based on a condition that a driver is seated on a seat. Specifically, the right-and-left direction in FIG. 2 corresponds to the back-and-forth direction. The term “front (of the vehicle)” refers to the front defined based on the condition that the driver is seated on the seat. Specifically, the left in FIG. 2 corresponds to the front.

### [Drive Unit]

A drive unit 100 is installed in a vehicle. The drive unit 100 is configured to move the vehicle forward and rearward. As shown in FIGS. 1 and 2, the drive unit 100, installed in the vehicle, includes a first drive part 1, a second drive part 2, a power transmission mechanism 3, and a controller 4. The drive unit 100 is configured to drive an output unit 5. It should be noted that the output unit 5 includes a differential gear 51, a pair of drive shafts 52, and a pair of drive wheels 53. The output unit 5 may include only the pair of drive wheels 53.

### [First Drive Part]

The first drive part 1 is configured to drive the output unit 5. The first drive part 1 includes a first electric motor 10, a first torque converter 11, a first clutch 12, and a first transmission shaft 13. In the first drive part 1, the first electric motor 10 and the first torque converter 11 are disposed in this order from the front of the vehicle.

The first electric motor 10 is configured to be rotated in the first rotational direction. Additionally, the first electric motor 10 is configured to be rotated in the second rotational direction as well. When the first electric motor 10 is rotated in the first rotational direction, the vehicle is moved forward. Contrarily, when the first electric motor 10 is rotated in the second rotational direction, the vehicle is moved rearward. A torque, generated when the first electric motor 10 is rotated in the first rotational direction, is transmitted to the first transmission shaft 13 through the first torque converter 11. By contrast, a torque, generated when the first electric motor 10 is rotated in the second rotational direction, is transmitted to the first transmission shaft 13 through the first clutch 12.

The first electric motor 10 includes a first motor case 101, a first motor stator 102, and a first rotor 103. The first motor case 101 is non-rotatable, while being fixed to a body frame of the vehicle or so forth.

The first motor stator 102 is fixed to the inner peripheral surface of the first motor case 101. The first motor stator 102 is non-rotatable. The first rotor 103 is rotated about a rotational axis O. The first rotor 103 is disposed radially inside the first motor stator 102. In other words, the first electric motor 10 is of a so-called inner rotor type.

The first torque converter 11 is a device to which the torque generated by the first electric motor 10 is inputted. The first torque converter 11 is configured to amplify the torque generated by the first electric motor 10 when the torque is directed in the first rotational direction. In other words, when the first electric motor 10 is rotated in the first rotational direction, the first torque converter 11 amplifies the torque directed in the first rotational direction and transmits the amplified torque to the first transmission shaft 13. It should be noted that the first torque converter 11 does not amplify the torque generated by the first electric motor 10 when the torque is directed in the second rotational direction. The first torque converter 11 outputs the amplified torque to the first transmission shaft 13.

The first torque converter 11 includes a first cover 110, a first impeller 111, a first turbine 112, and a first stator 113. Additionally, the first torque converter 11 includes a lock-up clutch 115 that directly transmits the torque generated by the first electric motor 10 to the first turbine 112. Then, the torque is outputted from the first turbine 112 so as to be transmitted to the first transmission shaft 13.

The first clutch 12 is disposed inside the first torque converter 11. The first clutch 12 allows transmission of the torque generated by the first electric motor 10 to the first transmission shaft 13 when the torque is directed in the second rotational direction. On the other hand, the first clutch 12 blocks transmission of the torque generated by the first electric motor 10 to the first transmission shaft 13 when the torque is directed in the first rotational direction. In other words, when the first electric motor 10 is rotated in the second rotational direction, the first clutch 12 transmits the torque directed in the second rotational direction to the first transmission shaft 13. On the other hand, when the first electric motor 10 is rotated in the first rotational direction, the first torque converter 11 transmits the torque directed in the first rotational direction to the first transmission shaft 13. It should be noted that a one-way clutch, for instance, is provided as the first clutch 12.

### [Second Drive Part]

The second drive part 2 is configured to drive the output unit 5. The second drive part 2 is aligned with the first drive part 1 along the back-and-forth direction of the vehicle. In the present embodiment, the first and second drive parts 1 and 2 are disposed coaxial to each other such that the rotational axes thereof are matched with each other. The second drive part 2 includes a second electric motor 20, a second torque converter 21, a second clutch 22, and a second transmission shaft 23. In the second drive part 2, the second torque converter 21 and the second electric motor 20 are disposed in this order from the front of the vehicle. In other words, the first and second drive parts 1 and 2 are different in positional relation between the electric motor 10, and the torque converter 11, 21.

The second electric motor 20 is configured to be rotated not only in the first rotational direction but also in the second rotational direction. When the second electric motor 20 is rotated in the first rotational direction, the vehicle is moved forward. Contrarily, when the second electric motor 20 is rotated in the second rotational direction, the vehicle is moved rearward. It should be noted that as seen from the front of the vehicle (the left side in FIG. 2), the first rotational direction of the first electric motor 10 and that of the second electric motor 20 are identical to each other. For example, suppose the vehicle is configured to be moved forward when the first electric motor 10 is rotated clockwise as seen from the left side in FIG. 2; then, the vehicle is moved forward as well when the second electric motor 20 is rotated clockwise as seen from the left side in FIG. 2.

A torque, generated when the second electric motor 20 is rotated in the second rotational direction, is transmitted to the second transmission shaft 23 through the second torque converter 21. By contrast, a torque, generated when the second electric motor 20 is rotated in the first rotational direction, is transmitted to the second transmission shaft 23 through the second clutch 22.

The second electric motor 20 includes a second motor case 201, a second motor stator 202, and a second rotor 203. The structure of the second electric motor 20 is substantially identical to that of the first electric motor 10, and hence, the detailed explanation thereof will be omitted.

The second torque converter 21 is a device to which the torque generated by the second electric motor 20 is inputted. The second torque converter 21 is configured to amplify the torque generated by the second electric motor 20 when the torque is directed in the second rotational direction. In other words, when the second electric motor 20 is rotated in the second rotational direction, the second torque converter 21 amplifies the torque directed in the second rotational direction and transmits the amplified torque to the second transmission shaft 23. It should be noted that the second torque converter 21 does not amplify the torque generated by the second electric motor 20 when the torque is directed in the first rotational direction.

The second torque converter 21 includes a second impeller 211, a second turbine 212, a second stator 213, and the second clutch 22. It should be noted that unlike the first torque converter 11, the second torque converter 21 does not include any lock-up clutch, but alternatively, may include a lock-up clutch. The torque, outputted from the second turbine 212, is transmitted to the second transmission shaft 23.

The second clutch 22 is disposed inside the second torque converter 21. The second clutch 22 allows transmission of the torque generated by the second electric motor 20 to the second transmission shaft 23 when the torque is directed in the first rotational direction. On the other hand, the second clutch 22 blocks transmission of the torque generated by the second electric motor 20 to the second transmission shaft 23 when the torque is directed in the second rotational direction. In other words, when the second electric motor 20 is rotated in the first rotational direction, the second clutch 22 transmits the torque directed in the first rotational direction to the transmission shaft 23. On the other hand, when the second electric motor 20 is rotated in the second rotational direction, the second torque converter 21 transmits the torque directed in the second rotational direction to the second transmission shaft 23. It should be noted that a one-way clutch, for instance, is provided as the second clutch 22.

### [Power Transmission Mechanism]

The power transmission mechanism 3 is configured to transmit the torque, inputted thereto from each of the first and second drive parts 1 and 2, to the output unit 5. Additionally, the power transmission mechanism 3 is configured to combine the torque inputted thereto from the first drive part 1 and that inputted thereto from the second drive part 2, and then, transmit a net torque obtained by combining the torques to the output unit 5. The power transmission mechanism 3 includes a first gear train 31, a second gear train 32, and an output shaft 35.

The first gear train 31 transmits the torque inputted thereto from the first drive part 1. The first gear train 31 includes a first input gear 31a and a first output gear 31b. The first input gear 31a is meshed with the first output gear 31b. The first input gear 31a is attached to the first transmission shaft 13. The first output gear 31b is attached to the output shaft 35.

The second gear train 32 transmits the torque inputted thereto from the second drive part 2. The second gear train 32 includes a second input gear 32a and a second output gear 32b. The second input gear 32a is meshed with the second output gear 32b. The second input gear 32a is attached to the second transmission shaft 23. The second output gear 32b is attached to the output shaft 35.

The first gear train 31 is equal in gear ratio to the second gear train 32. Each of the first and second gear trains 31 and 32 has a gear ratio greater than 1.0. In other words, the power transmission mechanism 3 functions as a reducer. It should be noted that the first gear train 31 may be different in gear ratio from the second gear train 32. In this case, the first gear train 31 is preferably greater in gear ratio than the second gear train 32. It should be noted that the first gear train 31 may be lesser in gear ratio than the second gear train 32.

### [Controller]

The controller 4 is configured to control the first and second electric motors 10 and 20. For example, a computer (e.g., microcomputer), including a CPU (Central Processing Unit), a ROM (Read Only Memory), and so forth, is provided as the controller 4. The ROM stores programs for various computations. The CPU executes the programs stored in the ROM.

First, a series of actions performed by the controller 4 in forward movement will be explained. In forward movement, the controller 4 executes a first forward movement mode, a second forward movement mode, a third forward movement mode, a first braking mode, and a second braking mode.

First, the first forward movement mode will be explained. In the first forward movement mode, the controller 4 drives both the first and second drive parts 1 and 2 so as to move the vehicle forward. When described in detail, the controller 4 rotates the first electric motor 10 in the first rotational direction, while rotating the second electric motor 20 in the first rotational direction.

Accordingly, the torque generated by the first electric motor 10 is amplified by the first torque converter 11; then, the amplified torque is transmitted therefrom to the output unit 5. On the other hand, the torque generated by the second electric motor 20 is transmitted to the output unit 5 through the second clutch 22. It should be noted that the torque generated by the second electric motor 20 is not amplified by the second torque converter 21. In other words, the second electric motor 20 is directly connected to the output unit 5.

As described above, in the first forward movement mode, the controller 4 uses both the first and second electric motors 10 and 20; hence, the first forward movement mode is suitable for high load traveling exemplified by a condition that the vehicle starts moving while being loaded with a large amount of goods.

Next, the second forward movement mode will be explained. In the second forward movement mode, the controller 4 drives only the first drive part 1 without driving the second drive part 2. When described in detail, the controller 4 rotates the first electric motor 10 in the first rotational direction while stopping the second electric motor 20.

Accordingly, the torque generated by the first electric motor 10 is amplified by the first torque converter 11; then, the amplified torque is transmitted therefrom to the output unit 5.

As described above, in the second forward movement mode, the controller 4 uses only the first electric motor 10; hence, the second forward movement mode is suitable for moderate load traveling, in which a lower load acts on the vehicle than in the first forward movement mode, and that is exemplified by a condition that the vehicle starts moving while being loaded with a small amount of goods.

Subsequently, the third forward movement mode will be explained. In the third forward movement mode, the controller 4 drives only the second drive part 2 without driving the first drive part 1. When described in detail, the controller 4 rotates the second electric motor 20 in the first rotational direction, while idling the first electric motor 10.

Accordingly, the torque generated by the second electric motor 20 is transmitted to the output unit 5 through the second clutch 22. The torque generated by the second electric motor is not amplified by the second torque converter 21. In other words, the second electric motor is directly connected to the output unit 5.

As described above, in the third forward movement mode, the controller 4 uses only the second electric motor 20 but the torque generated by the second electric motor 20 is not amplified; hence, the third forward movement mode is suitable for low load traveling, in which a lower load acts on the vehicle than in the second forward movement mode, and that is exemplified by steady traveling.

Next, the braking modes in forward movement will be explained. First, the first braking mode will be explained. In deceleration during forward movement, the controller 4 is configured to execute the first and second braking modes. In the first braking mode, the controller 4 causes the first electric motor 10 to perform a regenerative action while stopping the second electric motor 20.

When described in detail, the controller 4 makes the first electric motor 10 rotatable by a torque transmitted from the output unit 5. Accordingly, when the torque directed in the first rotational direction is transmitted from the output unit 5 to the first electric motor 10 through the first clutch 12, the first electric motor 10 is rotated, whereby regenerative braking is actuated.

It should be noted that, when the torque directed in the first rotational direction is inputted to the second drive part 2 from the output unit 5, transmission of the torque is blocked at the second clutch 22. Additionally, the second electric motor 20 is stopped. Because of this, in the second torque converter 21, not the second impeller 211 but only the second turbine 212 is rotated by the first rotation directional torque inputted to the second drive part 2 from the output unit 5.

Next, the second braking mode will be explained. In the second braking mode, the controller 4 causes the first electric motor 10 to perform a regenerative action, while rotating the second electric motor 20 in the second rotational direction. When described in detail, the controller 4 makes the first electric motor 10 rotatable by the torque transmitted from the output unit 5. Accordingly, when the torque directed in the first rotational direction is transmitted from the output unit 5 to the first electric motor 10 through the first clutch 12, the first electric motor 10 is rotated, whereby regenerative braking is actuated.

Additionally, the controller 4 rotates the second electric motor 20 in the second rotational direction, whereby the second torque converter 21 can be used as a fluid retarder.

As described above, the second braking mode is suitable for traveling, in which a greater braking force is required than in the first braking mode, and that is exemplified by a condition that the vehicle goes downhill, while being loaded with a large amount of goods.

Next, a series of actions performed by the controller 4 in rearward movement will be explained. In rearward movement, the controller 4 executes a first rearward movement mode, a second rearward movement mode, a third rearward movement mode, and a third braking mode.

First, the first rearward movement mode will be explained. In the first rearward movement mode, the controller 4 drives both the first and second drive parts 1 and 2 so as to move the vehicle rearward. When described in detail, the controller 4 rotates the first electric motor 10 in the second rotational direction, while rotating the second electric motor 20 in the second rotational direction.

Accordingly, the torque generated by the first electric motor 10 is transmitted to the output unit 5 through the first clutch 12. It should be noted that the torque generated by the first electric motor 10 is not amplified by the first torque converter 11. In other words, the first electric motor 10 is directly connected to the output unit 5. On the other hand, the torque generated by the second electric motor 20 is amplified by the second torque converter 21; then, the amplified torque is transmitted therefrom to the output unit 5.

Next, the second rearward movement mode will be explained. In the second rearward movement mode, the controller 4 drives only the second drive part 2 without driving the first drive part 1. When described in detail, the controller 4 rotates the second electric motor 20 in the second rotational direction, while stopping the first electric motor 10.

Accordingly, the torque generated by the second electric motor 20 is amplified by the second torque converter 21; then, the amplified torque is transmitted therefrom to the output unit 5. It should be noted that, when the torque directed in the second rotational direction is inputted to the first drive part 1 from the output unit 5, transmission of the torque is blocked at the first clutch 12; hence, the torque is not transmitted to the first electric motor 10.

Subsequently, the third rearward movement mode will be explained. In the third rearward movement mode, the controller 4 drives only the first drive part 1 without driving the second drive part 2. When described in detail, the controller 4 rotates the first electric motor 10 in the second rotational direction while idling the second electric motor 20.

Accordingly, the torque generated by the first electric motor 10 is transmitted to the output unit 5 through the first clutch 12. It should be noted that the torque generated by the first electric motor 10 is not amplified by the first torque converter 11. In other words, the first electric motor 10 is directly connected to the output unit 5. On the other hand, when the torque directed in the second rotational direction is inputted to the second clutch 22 from the output unit 5, transmission of the torque to the second electric motor 20 is allowed by the second clutch 22.

Next, the third braking mode, executed as a braking mode in rearward movement, will be explained. In deceleration during rearward movement, the controller 4 is configured to execute the third braking mode. In the third braking mode, the controller 4 stops the first electric motor 10, while causing the second electric motor 20 to perform a regenerative action.

When described in detail, the controller 4 makes the second electric motor 20 rotatable by the torque transmitted from the output unit 5. Accordingly, when the torque is transmitted from the output unit 5 to the second electric motor 20 through the second clutch 22, the second electric motor 20 is rotated, whereby regenerative braking is actuated.

It should be noted that, when the torque directed in the second rotational direction is inputted to the first drive part 1 from the output unit 5, transmission of the torque is blocked at the first clutch 12. Additionally, the first electric motor 10 is stopped. Because of this, in the first torque converter 11, not the first impeller 111 but only the first turbine 112 is rotated by the second rotation directional torque inputted to the first drive part 1 from the output unit 5.

### [Actions]

In the drive unit 100 configured as described above, the controller 4 executes either the first forward movement mode or the second forward movement mode when the vehicle starts moving. It should be noted that either the first forward movement mode or the second forward movement mode is selected in response to the operation by the driver.

The controller 4 executes the third forward movement mode based on, for instance, a vehicle speed. For example, when the vehicle speed becomes a first threshold, the controller 4 is switched from the first forward movement mode to the third forward movement mode. On the other hand, when the vehicle speed becomes a second threshold, the controller 4 is switched from the second forward movement mode to the third forward movement mode. It should be noted that the second threshold is lesser in magnitude than the first threshold.

In deceleration of the vehicle, the controller 4 executes either the first braking mode or the second braking mode. The controller 4 executes the first braking mode based on, for instance, an accelerator opening degree. Additionally, the controller 4 is switched from the first braking mode to the second braking mode, for instance, in response to the operation performed by the driver after deceleration is made in the first braking mode.

Likewise, in rearward movement of the vehicle, the controller 4 selects one of the first rearward movement mode, the second rearward movement mode, and the third braking mode and executes the selected one in response to the operation by the driver or based on a traveling condition or so forth.

### [Modifications]

One embodiment of the present invention has been explained above. However, the present invention is not limited to the above, and a variety of changes can be made without departing from the gist of the present invention. It should be noted that basically speaking, modifications to be described are applicable simultaneously.

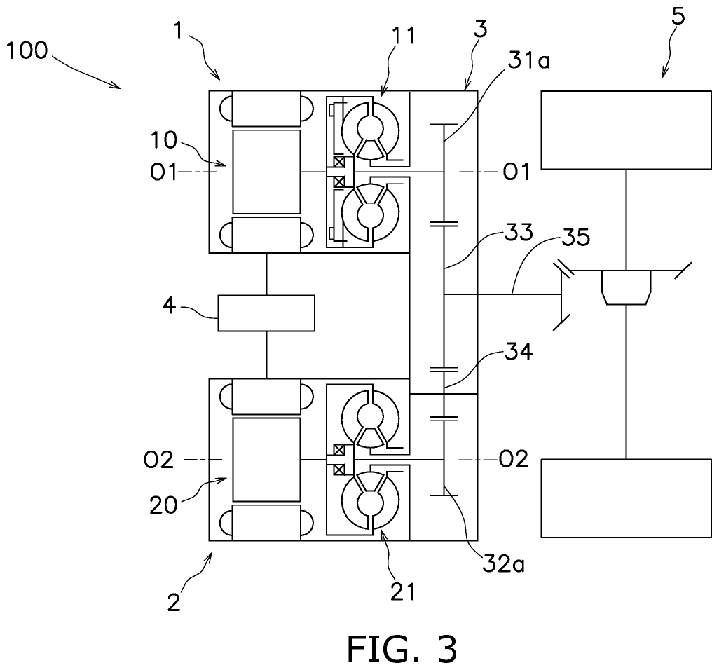

(a) In the embodiment described above, the first and second drive parts 1 and 2 are disposed to be different in positional relation between the electric motor 10, 20 and the torque converter 11, 21; however, the alignment of the respective members in the first drive part 1 and that in the second drive part 2 are not limited to the above. The first and second drive parts 1 and 2 may be disposed to be identical in positional relation between the electric motor 10, 20 and the torque converter 11, 21. For example, as shown in FIG. 3, in the first drive part 1, the first electric motor 10 and the first torque converter 11 are disposed in this order from the front of the vehicle (the left side in FIG. 3). In the second drive part 2, the second electric motor 20 and the second torque converter 21 are disposed in this order from the front of the vehicle.

It should be noted that in the modification, the first and second drive parts 1 and 2 are aligned along the width direction of the vehicle (the up-and-down direction in FIG. 3). The first and second drive parts 1 and 2 are disposed not coaxial to each other such that rotational axes O1 and O2 thereof are not matched with each other. Preferably, the rotational axis O1 of the first drive part 1 extends substantially in parallel to the rotational axis O2 of the second drive part 2.

In the modification, the power transmission mechanism 3 includes a reverse gear 34. For example, the second gear train 32 includes the reverse gear 34. It should be noted that not the second gear train 32 but the first gear train 31 may include the reverse gear 34. The modification is different from the embodiment described above in that the first and second gear trains 31 and 32 include a common output gear 33 without including the discrete output gears 31b and 32b.

The reverse gear 34 is disposed between the second input gear 32a and the output gear 33. The reverse gear 34 is meshed with the second input gear 32a and the output gear 33.

The first gear train 31 is different in gear ratio from the second gear train 32. For example, the first gear train 31 is lesser in gear ratio than the second gear train 32. It should be noted that the first gear train 31 may be greater in gear ratio than the second gear train 32. Alternatively, the first gear train 31 may be equal in gear ratio to the second gear train 32.

In the modification, as seen from the front of the vehicle, the first rotational direction of the first electric motor 10 and that of the second electric motor 20 are different from each other. Specifically, when the first rotational direction of the first electric motor 10 is set clockwise as seen from the left side in FIG. 3, the first rotational direction of the second electric motor 20 is set counterclockwise as seen from the left side in FIG. 3. Because of this, for example, suppose the vehicle is configured to be moved forward when the first electric motor 10 is rotated clockwise; then, the vehicle is moved forward when the second electric motor 20 is rotated counterclockwise as seen from the left side in FIG. 3.

(b) In the embodiment described above, the one-way clutches are provided as the first and second clutches 12 and 22; however, the configurations of the first and second clutches 12 and 22 are not limited to the above. For example, the first and second clutches 12 and 22 may be configured to be controlled electronically.

(c) In the embodiment described above, either the first forward movement mode or the second forward movement mode is selected in response to the operation by the driver; alternatively, the controller 4 may select either the first forward movement mode or the second forward movement mode based on a traveling condition or so forth.

(d) In the embodiment described above, the controller 4 executes the third forward movement mode based on the vehicle speed; alternatively, the controller 4 may execute the third forward movement mode in response to the operation by the driver, or other than this, based on a traveling condition or so forth.

(e) In the embodiment described above, the controller 4 executes the first braking mode based on the accelerator opening degree; alternatively, the controller 4 may execute the first braking mode in response to the operation by the driver, or other than this, based on a traveling condition or so forth. Besides, in the embodiment described above, the controller 4 is switched from the first braking mode to the second braking mode in response to the operation by the driver; alternatively, this switching may be executed based on a traveling condition or so forth. For example, the controller 4 may be switched from the first braking mode to the second braking mode when determining that the vehicle speed becomes a predetermined speed after deceleration is made in the first braking mode.

### REFERENCE SIGNS LIST

1: First drive part
10: First electric motor
11: First torque converter
12: First clutch
2: Second drive part
20: Second electric motor
21: Second torque converter
22: Second clutch
3: Power transmission mechanism
34: Reverse gear
4: Controller
5: Output unit

What is claimed is:

1. A drive unit for moving a vehicle forward and rearward, the drive unit comprising:
a first drive part including a first electric motor and a first torque converter, the first electric motor configured to be rotated in a first rotational direction so as to move the vehicle forward, the first electric motor configured to be rotated in a second rotational direction so as to move the vehicle rearward, the first torque converter configured to amplify a torque generated by the first electric motor when the torque generated by the first electric motor is directed in the first rotational direction; and
a second drive part including a second electric motor and a second torque converter, the second electric motor configured to be rotated in the first rotational direction and the second rotational direction, the second torque converter configured to amplify a torque generated by the second electric motor when the torque generated by the second electric motor is directed in the second rotational direction.

2. The drive unit according to claim 1, wherein the first drive part includes a first clutch, the first clutch configured to allow transmission of the torque generated by the first electric motor when the torque generated by the first electric motor is directed in the second rotational direction, the first clutch configured to block transmission of the torque generated by the first electric motor when the torque generated by the first electric motor is directed in the first rotational direction.

3. The drive unit according to claim 1, wherein the second drive part includes a second clutch, the second clutch configured to allow transmission of the torque generated by the second electric motor when the torque generated by the second electric motor is directed in the first rotational direction, the second clutch configured to block transmission of the torque generated by the second electric motor when the torque generated by the second electric motor is directed in the second rotational direction.

4. The drive unit according to claim 1, wherein the first and second drive parts are different in positional relation between each of the first and second electric motors and each of the first and second torque converters.

5. The drive unit according to claim 1, wherein the first and second drive parts are identical in positional relation between each of the first and second electric motors and each of the first and second torque converters.

6. The drive unit according to claim 5, further comprising:
a power transmission mechanism configured to transmit the torque inputted thereto from each of the first and second drive parts to an output unit, wherein
the power transmission mechanism includes a reverse gear through which rotation of the first or second electric motor is outputted to the output unit after the rotation is reversed in direction.

7. The drive unit according to claim 1, further comprising:
a controller configured to control the first and second electric motors, wherein
the controller is configured to execute a first forward movement mode such that the first electric motor is rotated in the first rotational direction, while the second electric motor is rotated in the first rotational direction.

8. The drive unit according to claim 7, wherein the controller is configured to execute a second forward movement mode such that the first electric motor is rotated in the first rotational direction, while the second electric motor is stopped.

9. The drive unit according to claim 7, wherein the controller is configured to execute a third forward movement mode such that the first electric motor is idled, while the second electric motor is rotated in the first rotational direction.

10. The drive unit according to claim 7, wherein the controller is configured to execute a first braking mode such that in deceleration during forward movement, the first electric motor is caused to perform a regenerative action, while the second electric motor is stopped.

11. The drive unit according to claim 7, wherein the controller is configured to execute a second braking mode such that in deceleration during forward movement, the first electric motor is caused to perform a regenerative action, while the second electric motor is rotated in the second rotational direction.

12. The drive unit according to claim 7, wherein the controller is configured to execute a first rearward movement mode such that the first electric motor is rotated in the second rotational direction, while the second electric motor is rotated in the second rotational direction.

13. The drive unit according to claim 7, wherein the controller is configured to execute a second rearward movement mode such that the first electric motor is stopped, while the second electric motor is rotated in the second rotational direction.
